(19) United States
(12) Patent Application Publication
(10) Pub. No.: US 2003/0163458 A1
(43) Pub. Date: Aug. 28, 2003

(54) Method and apparatus for storing and retrieving data

(76) Inventors: Sabine Guerry, London (GB); Punit Ram-Rakha, London (GB)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/258,262

(22) PCT Filed: Apr. 19, 2001
(86) PCT No.: PCT/GB01/01786

(30) Foreign Application Priority Data
Apr. 20, 2000 (GB) 0009883.0

(51) Int. Cl. G06F 7/00

(52) U.S. Cl. 707/3

(57) ABSTRACT

A method and apparatus for retrieval of data relating to a plurality of levels of information comprises a store and a retrieval engine. These are arranged so that a plurality of storage areas are divided into a plurality of segments. Data relating to a given level of information for a topic is stored in a segment of one of the storage areas and data relating to at least one other level of information on the topic is stored in a corresponding segment of at least one other one of the storage areas. The retrieval engine comprising determines a selected level of information on a topic to be retrieved in response to a user request and is arranged to retrieve other levels of information on request or automatically.

### FIELD OF THE INVENTION

The present invention relates to the storage and retrieval of data in an efficient manner. In particular, the invention relates to data storage accessible by the World Wide Web.

### BACKGROUND OF THE INVENTION

The World Wide Web has developed in recent years to provide a useful information resource. The Web, as is well-known, operates using Hypertext Markup Language (HTML) transmitted over Internet Protocol (IP). These techniques are well-known and require no further explanation.

The storage of data for display on the web at a server computer is effected by storing separate ‘pages’ of data, each page being stored as a separate file. Links between pages are achieved through codes associated with highlighted words, buttons, graphics or other indicia.

The World Wide Web has allowed customising of data content presented to a user to an extent. So far however, the customisation has been “horizontal” by which we mean that customers choose a domain of interest and the content is selected so that every time a customer logs into the web-site, the relevant topic is shown on the home page.

The “horizontal” customisation described above does not allow customers to decide on the level or depth of the information they are getting. It ignores the reality that customers have different levels of knowledge on a given topic and that the information being sought after can be of very different depth, level of details and complexity from one customer to another.

We have appreciated deficiencies in the existing storage of data for use on the Web. In particular, we have appreciated the need to improve the customisation of data stored for display to a given user.

In a broad aspect the invention relates to an improved system and method for data storage. More particularly, the invention relates to a system and method for storing data in such a manner that retrieval of data can be determined based on a level of content required. The invention is defined in the claims to which reference is now directed. The invention provides the ability to store and retrieve data in such a manner that a viewer/customer has the option of choosing a complexity or level of content retrieved.

In particular on complex or technical topics such as medicine, the ability to customise the content <<vertically>> or <<by level of complexity>> is an important invention in electronic publishing. It allows catering for a greater number of customers, and fulfilling their need regardless of their previous knowledge. It is also a major educational tool since it allows customers to read the basic information before accessing more complex levels of information.

The invention may be embodied in a variety of technical systems. The preferred embodiment, now to be described, stores data in such a manner that it is accessible on the World Wide Web. The invention is also applicable, however to other systems such as Intra-Nets, CD-based services, WAP and other current and emerging technologies.

### BRIEF DESCRIPTION OF THE FIGURES

An embodiment of the invention will now be described, by way of example only, in which:

FIG. 1 shows a computer server which may embody the invention;

FIG. 2 shows a server computer of FIG. 1;

FIG. 3 shows the division of a repository of data to form a database;

FIG. 4 shows how keywords are stored in a data structure embodying the invention;

FIG. 5 shows a data structure embodying the invention;

FIG. 6 shows a storage table for storing data relating to customer or client use;

FIG. 7 shows the relationship between the customer data and the data structure of FIG. 6;

FIG. 8 is a flow diagram showing information retrieval in the embodiment of the invention;

FIG. 9 is a flow diagram showing how a customer may change default level; and

FIG. 10 is a flow diagram showing information retrieval in the event of missing data at one or more levels.

### DESCRIPTION OF A PREFERRED EMBODIMENT

The embodiment of the invention comprises two principal components: a data store with a given structure as will be described, and a retrieval engine for retrieving data from the data store in such a way that information can be displayed to a user. These two components operating together ensure that a user seeking information on a particular topic can be presented with the information at an appropriate level of complexity.

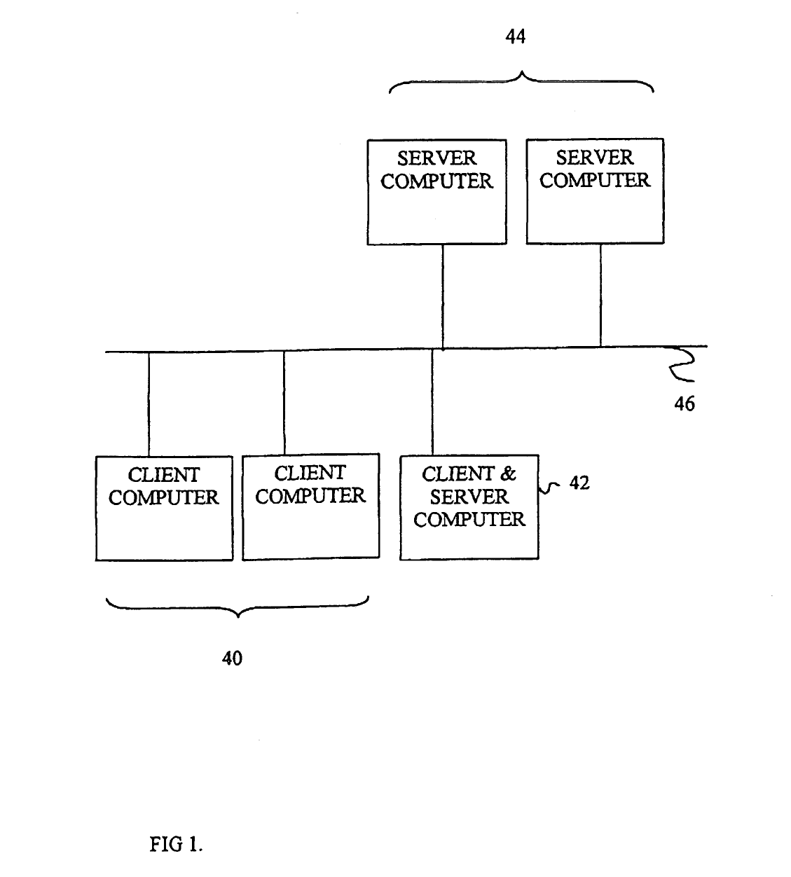

The system embodying the invention could be developed using a variety of technologies. An overview of the system is shown in FIG. 1.

The embodiment shown is a computer network such as the Internet or an Intranet and comprises a plurality of client computers 40, a client and server computer 42 and one or more server computers 44 connected together by a computer network (bus) 46 or other communication path. A client computer 40 is used directly by a user and runs various applications software. A server-computer 44 acts as a permanent repository of data held in a data store as a database and including a retrieval engine. In general, any client computer 40 can access data stored on any server computer 44. Some computers 42 are both a client computer and a server computer. Such a computer 42 can access data stored on itself, as well as other computers 44. Other computers 40 can also access data on a client and server computer 42. The invention can be embodied on a system that has at least one client and server computer 42 or one each of a client 40 and server computer 44 connected by a computer network or communication path 46. For simplicity, a client computer 40 or a computer 42 when acting as a client computer will be referred to as “client” and a server computer 44 or a computer 42 acting as a server will be referred to as a “server”.

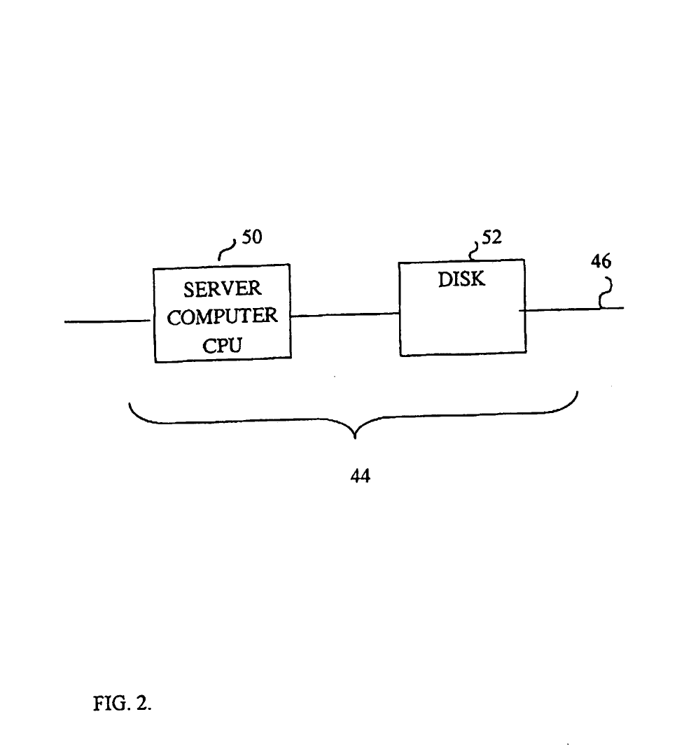

The server computer 44 is further shown in FIG. 2 and comprises a central processing unit (CPU) 50 for executing the retrieval engine connected with a disk or other mass storage medium 52 which is a permanent repository of data for one or more databases to act as data stores. CPU 50 moves data between disk 52 and network 46.

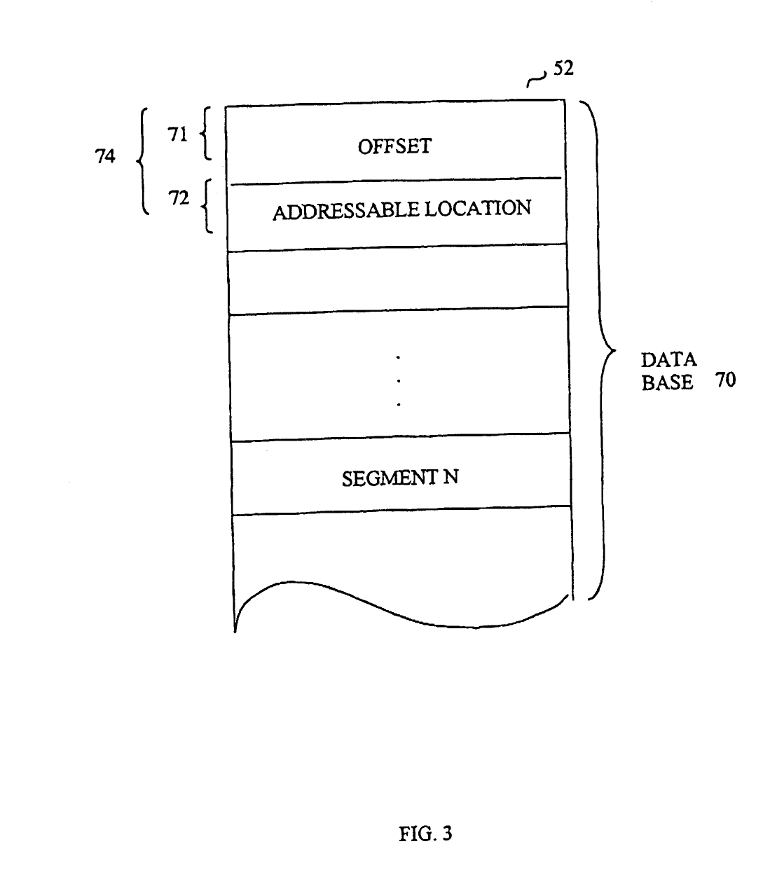

The data store 52 and structure thereof is shown in greater detail in FIGS. 3 to 5. The data store is divided into basic units called segments 74 which store information to be displayed to a user and are addressable. The segments 74 form a database 70. There are a plurality of such databases with information at any given level being stored in segments within one database, and information at other levels being stored in corresponding segments in other databases. Whilst this is the preferred structure, it should be appreciated that this is a logical, rather than physical structure and a single database could be used which is divided into groups of segments with information at a given level stored within segments of a given group. The term segment means an addressable individual storage area.

The segments 74 are each addressable in such a manner that segments containing the same subject matter or topic of information, but at different content levels, share a common address, but differ in the database within which they are logically contained. Each segment is also referenced by one or more keywords or group of keywords such that segments relating to the same subject matter share keywords. A group of segments relating to the same subject matter, with each segment stored in a different one of the databases is known as a “combined segment”. Similarly, groups of databases are known as “combined databases” and information stored in combined segments is known as “combined information”.

Whilst the simplest relationship between “combined segments” is to share a common address in their respective database, it should be appreciated that more complex relationships between combined segment adresses could be implemented (ex: address of level (n+1)=address of level n+100).

The structure of one database of the plurality of databases is shown in FIG. 3. The division of the permanent repository store of data 52 forms a plurality of databases 70. Each database 70 is subsequently divided into at least one segment 74. Each segment contains a number of addressable locations 72, which can be addressed by an offset 71 from the beginning of any given segment 74. An addressable location in the database is also assigned a persistent address. This assignment of the persistent address space is performed separately for each segment 74 of a database 70. A location 72 can contain a value or a pointer corresponding to a persistent address. A pointer can point to other segments in the database. Assignment on the persistent address space of a segment is performed only for that segment and segments to which it contains pointers.

The purpose of each persistent address is to allow the retrieval engine to select appropriate segments for display and change to corresponding segments of other databases, if requested. This process is described in detail later. Each segment 74 is divided into at least one page 80. The size of a page is predetermined by the computer hardware.

Although segments appear to be adjacent in the illustration FIG. 3, in actuality, these segments (and even parts of these segments) can appear anywhere on the disk. A standard disk file system can monitor the location of data segments and their corresponding information segments.

Each segment 74 contains at least one entry, but will have more than one entry if its pages are not contiguous, or of it contains pointers to other segments. However, the number of entries is minimized if possible.

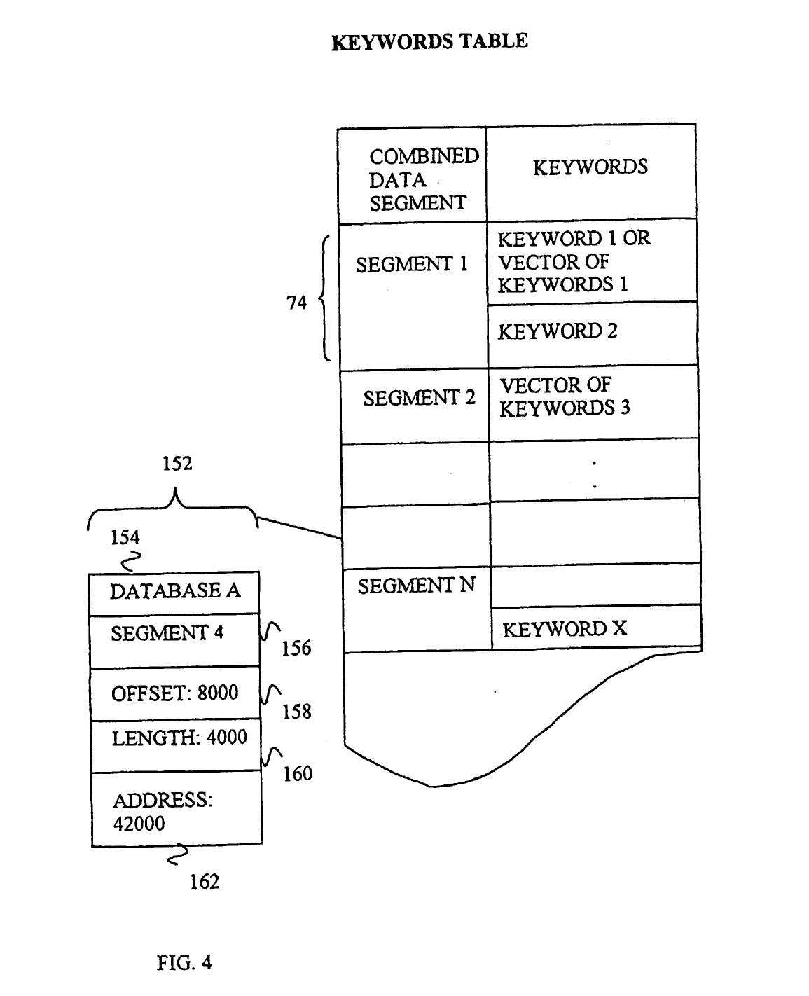

A typical entry 152 for a set of pages contains five fields. Database field 154 contains a coded value indicating the database in which the set of pages resides. Segment field 156 indicates the segment of the database 154 in which the set of pages is located. Offset field 158 indicates the distance from beginning of the segment 156 at which this set of pages begins. Lengh field 160 indicates the lengh or size of this page set and can be an integer for the number of pages or preferably the total length in bytes of all pages for this entry. As an example, the entry shown in FIG. 4 of database A, segment 4, offset 8000 and length 4000 indicates that this entry corresponds to a page of database A, located in segment 4, beginning at location 8000 addressable units from the beginning of segment 4 and having a length of 4000 units. Finally, address field 162 indicates the persistent address for the first addressable location of this page (e.g. 42,000). The address field 162 and lengh field 160 indicate that persistent address 42,000 to 46,000 are allocated to this set of pages of database A, segment 4, and beginning at offset 8,000. As a result, the address of the combined information stored in combined segments of combined databases will have a different database field but a common (or related) segment field. Since the length of the info can vary from one level to another, offset field, length field and address field will vary from one level to another.

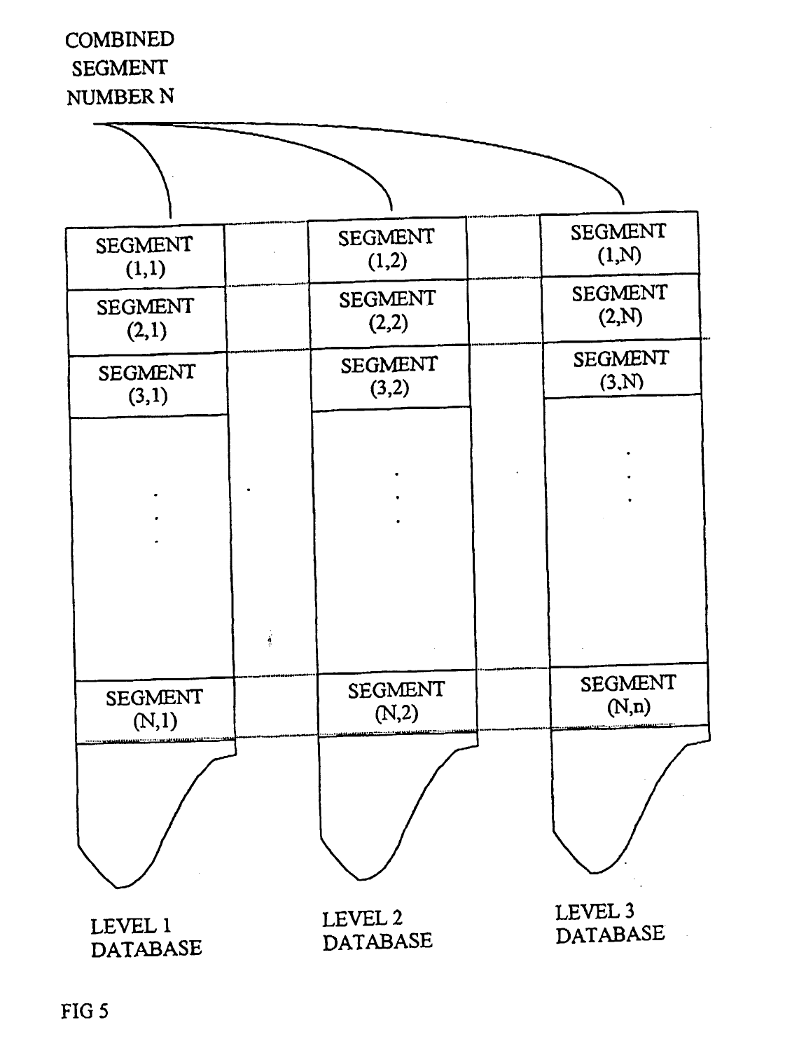

The overall structure of the data store 52 divided into n databases with N segments in each database as shown in FIG. 5, which stores n identical databases, each corresponding to a specific level of content. These n databases are defined as “combined” databases. Segments are numbered from 1 to N in each database in the same way from database 1 to database n. In our preferred embodiment of the invention, segments with the same number in their respective combined database are called “combined segments”. Their address only differs in the name (or number) of their database.

Typically, to retrieve information, a user will specify one or more keywords. These are related to segments in each data base and corresponding segments in other databases.

FIG. 4 illustrates the relationship table between keywords and segments. A segment is referenced by at least one keyword word that the operator can call in order to pull the segment from the database. A segment can also be referenced with a vector of keywords or a combination of keywords. For example “Diabete type II”. Segments relating to the same subject matter but from different databases are referenced with the same keywords or vector of keywords.

Thus, segments relating to the same subject matter are given the same segment number on their respective database or part of database and are known as combined segments. Accordingly, any given segment relating to a topic shares the same segment number and keywords as other segments on that topic, but differs in the database (and hence the level) within which it is contained.

The choice of level made by the customer regarding the level of information requested defines the combined database from which the information is retrieved.

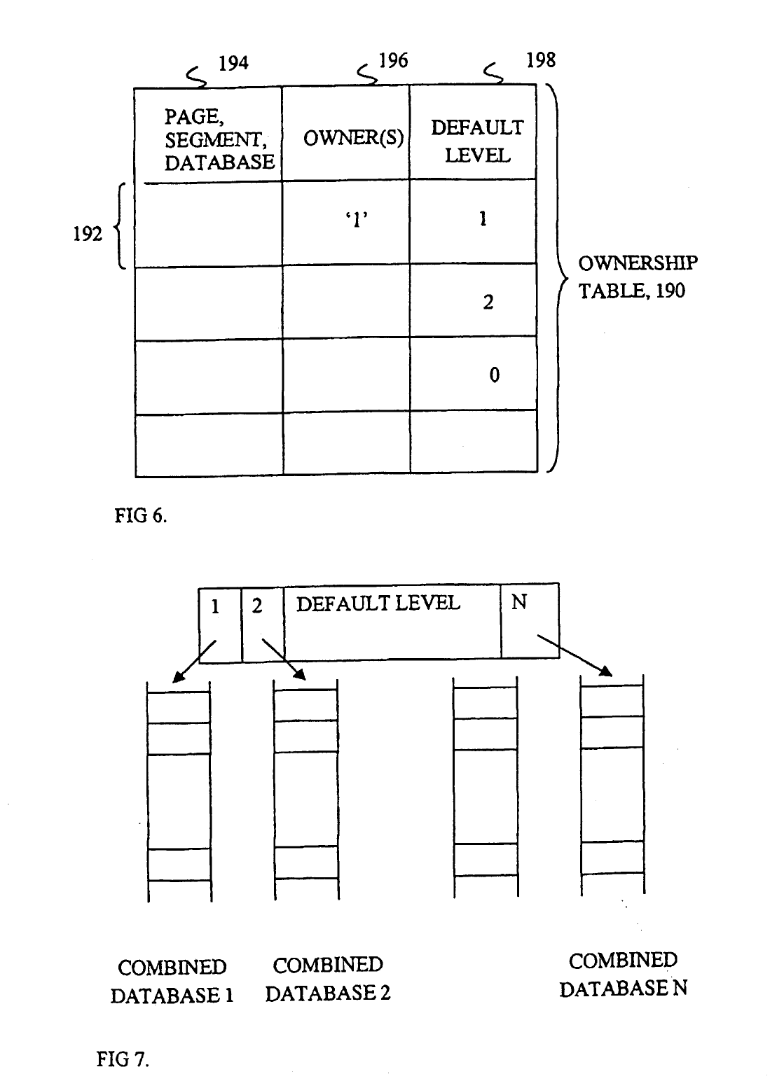

The data structure described allows any given segment to be retrieved with reference to a “combined segment” number and the name/number of a database. Accordingly, a search of the data store by keywords will retrieve a combined segment and allow the user the option of which level of information to view. This process will now be described with reference to FIGS. 6 to 10.

The level of information supplied to a user is a matter of choice. For any given request, a user has the option of viewing a choice of levels 1 to n. The level chosen is set as a default level and stored in an “ownership table” 190. The purpose of this table is to store the default level currently selected by any given user, as is shown in FIG. 6.

The ownership table 190 contains entries 192 comprising three fields. A content field 194 indicates a page of a database, with a page number, combined segment number and database name. The owner field 196 indicates which client or clients are currently using that page. The owner field is preferably an array of clients names. Finally, the status field 198 indicates what is the default data-level chosen by the owner. If the owner has not chosen a default data level, this field's value is zero.

FIG. 7 illustrates the relationship between the ownership table 190 and the combined databases. Each “default” level number refers to a given combined database and determines from which database of the combined information will be retrieved. When a keyword is entered by the customer, the retrieval engine identifies a combined segment via the “keyword table” and then looks at the “default number” table. It then looks for the appropriate segment in the appropriate combined database.

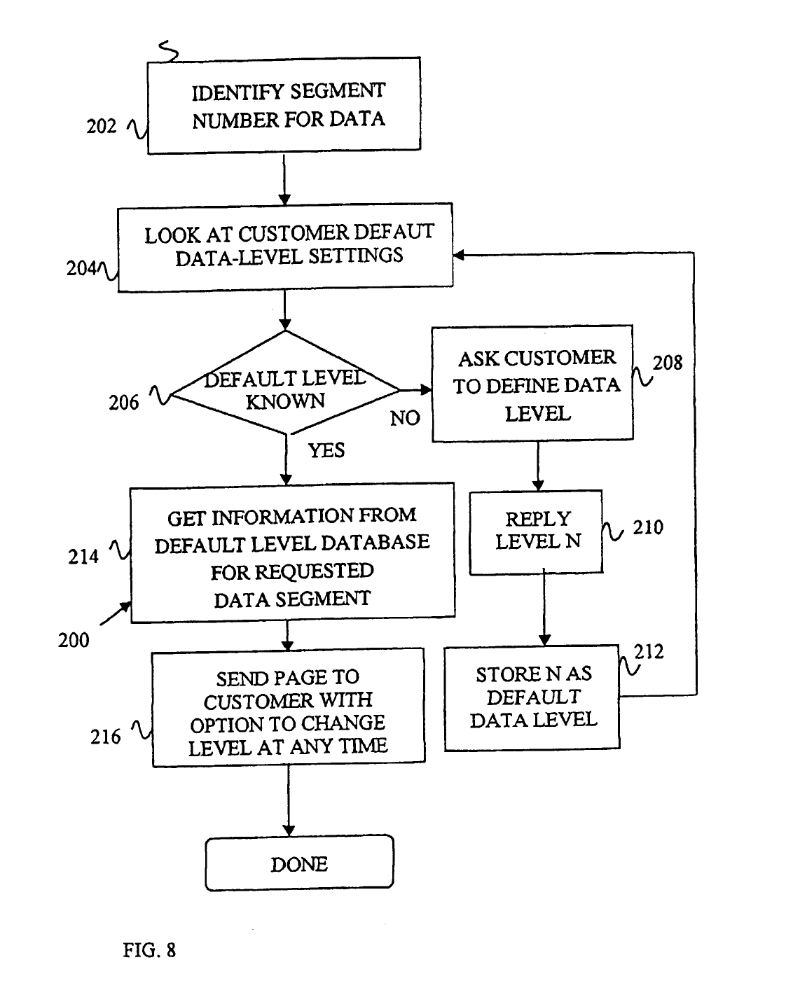

The retrieval engine aspect of the invention is shown in greater detail in FIGS. 8 to 10, which show the various processes undertaken. The retrieval engine 200 resides at the server 44 (FIG. 8) and operates as follows:

When a customer requests information, the combined segment number storing the data is identified during step 202 for all levels of database. The customer “default” data-level is looked at in the ownership table at step 204. This provides a function of a determiner. If this “default” data-level is unknown 206, the customer is asked to define it 208. Once the customer “default level,, is stored 210, 212, the default level is known.

When the default level is known, the complete address of the set of pages to be found is known and a request to access the information in the database previously identified is made 214. This provides a function of a retriever. A pointer to that set of pages is retrieved in any known way from which the database, segment and offset of the set of pages can be found. Given the pointer to a desired set of pages, the pointer can then perform the assignment from that segment and transfer the segment from server to client during step 216.

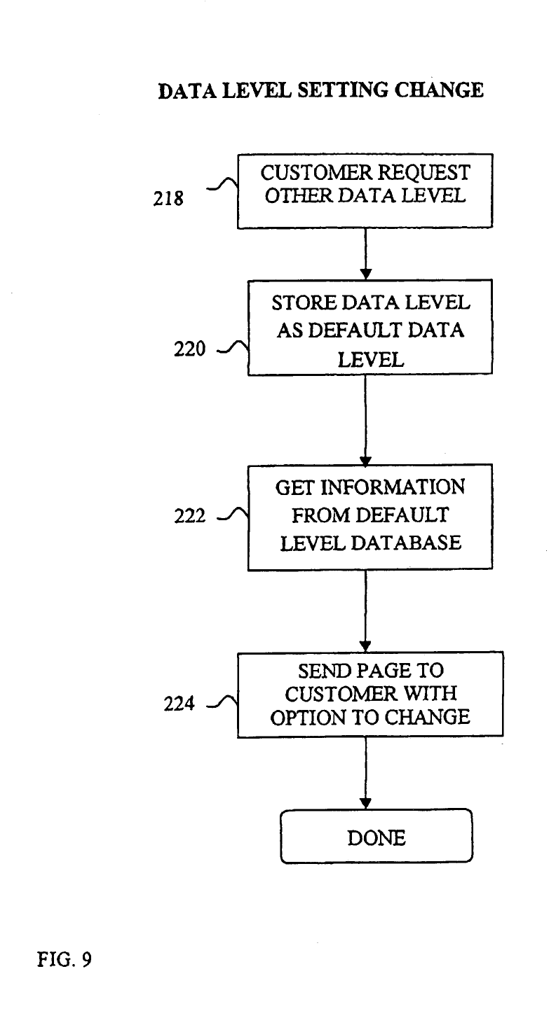

A customer may wish to change the default level of information viewed, and this can be done at any time. FIG. 9 describes how customer can change their default data level at any time. When a customer requests another data level 218 after a request has been executed, the new default data level is stored in place of the first one 220. An application looks at the address of the current page and modifies it with the new default data level (or database layer number). The application then requests access to the set of pages whose address matches the address constructed as described above 222. This provides the function of a second retriever. The pointer is then retrieved and the page transferred 224 as described in relation to FIG. 8.

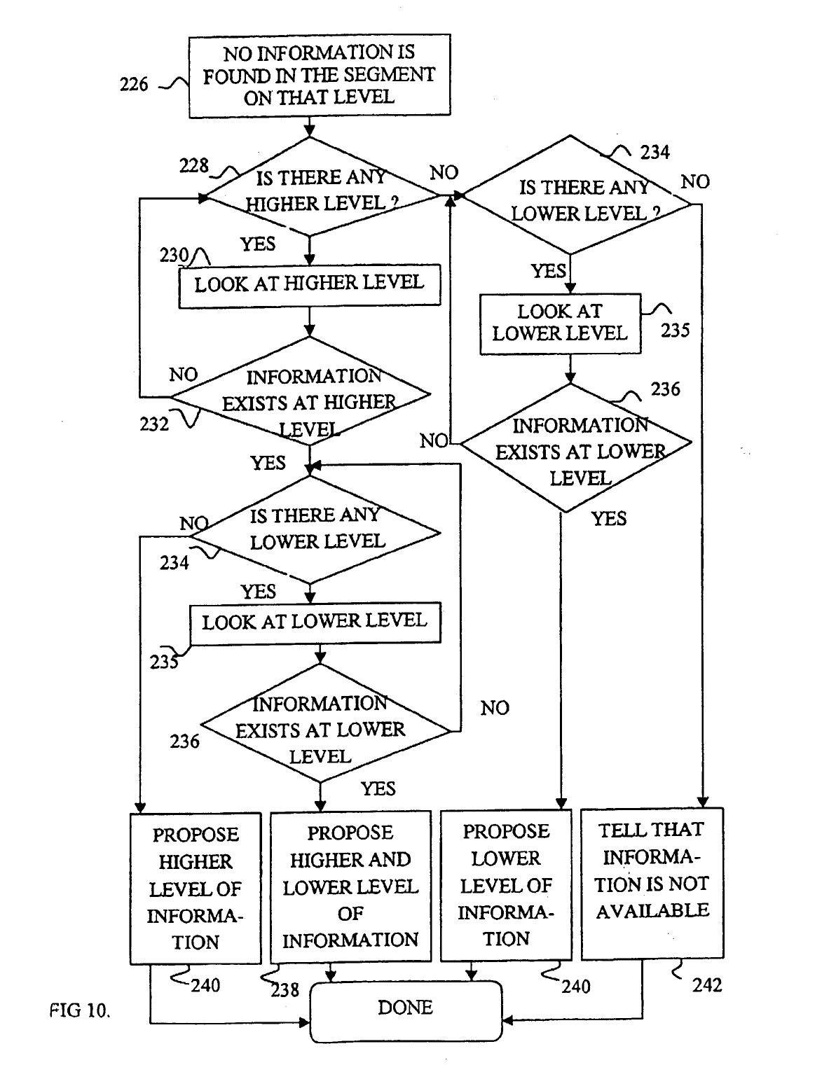

There are situations in which information may be available at certain levels, but, not others. The retrieval engine includes a process to handle such conflicts, as shown in FIG. 10. FIG. 10 is a flow chart showing the process involved when a combined database does not have the information requested by the customer (missing level).

When no object is found in the segment of the database from which the retrieval engine has requested access to the set of pages 226, the engine first looks if there is any higher level of database 228 (layer of the database with more complex information). If there is, the application verifies that there is some information stored in the combined address of this higher level database 230. If there is, 232, it looks if there is a lower level 234 than the one initially requested. If there is, it looks at the lower level, 235, and look if there is some information stored in the combined address of the lower level database 236.

In the case were there is an object in both the higher level of higher level of the combined databases, the application ask the customer whether he or she wants to retrieve the information from one of these levels 238. If the customer accepts and indicates which level the information should be retrieved from, the application retrieves and transfers the object from the appropriate database as shown in FIG. 8. If one of the adjacent combined levels does not exist or does not have any object in its combined address and has no higher or lower level, the software offers the customer the only available option 240. If there are several higher or lower levels, the application keeps looking at higher or lower level until it finds an object in the combined segments or until it reaches the highest or lowest level. If no information is available, the customer is informed (242).

An application of the embodiment will now be described.

The content on every given topic is developed several times with various levels of complexity. We will use as an example, three levels of complexity for a medical topic, with the understanding that it could be extended to n levels for any topic. For example, in a medical information system:

Level 1: general public with no previous knowledge of medicine.

Level 2: nurses or general public educated with some medical knowledge

Level 3: medical professionals specialists of the topics.

For a given topic, all the levels of content are referenced with the same keywords.

The content related to these keywords is stored in the segments of the database in three identically structured layers, each level of content being stored in one of the layers (FIG. 5). In our example level one is stored on the first layer of the database, level two on the second layer. Each layer of the database is divided into segments that can be called via the keywords. The different layers have therefore similar structure and identical number of segments and only differentiated by the level of content stored in the segments of the database: the level one layer has simple content, the level 2 layer more advanced content, etc. When the search/retrieval engine calls the content for a given keyword, it has the choice between the three relevant levels of content included in each of the layers of the database. It is the level of the content requested by the customer that will define from which layer the content is going to be pulled.

When the customer first looks for medical information on a web-site incorporating the invention, he or she is asked to define the level of complexity of the information requested. A <<content level box>> is shown on the screen, and the customer clicks on the level of her/his choice.

The information is stored as a <<default>> content level data in the database. From then, all content requested by that customer will be extracted from the layer of the database related to that level.

When the customers type a keyword, the search engine interrogates the “content level” box, and registers the “default content level” that the customer has submitted. If the customers have requested level 1, it then pulls the content stored in the first layer of the database in the segments referenced with the requested key word. If the customer has requested level 2, it pulled the content stored in the second layer of the database for that given keyword.

Customers also have the possibility to change level of information at any time. A <<change level>> button is available on the screen when customers access content. If customers click to require another level of content, the information is immediately stored as the new default level, and the information stored in the layer related to that new level is now pulled for the topic previously requested. Any other request will be answered according to that new <<default level>> afterward.

It is unlikely that all topics will require to have the same number of levels of content. Some topics have an inherent complexity and cannot be explained without any previous knowledge. In particular new areas of research might enter in the description of the science with difficult vocabulary and reference to previous knowledge. In this case, information might only be available at a high level of complexity. The low complexity levels might not have any information related to this particular area or keyword. In other cases, the content related to one particular level could be missing or under development while the other levels on the contrary are fully available.

In the case of a missing level of content, the space for that level will nevertheless be allocated in the database for the relevant keywords. If a customer requests the information that should be stored in that empty segment, a message will be informing customers that the content is not available and offering to look at other levels if the information is available at other levels.

For example, if a customer asks for an information that does not exist at the simplest level, a message will be pulled and sent to the customer to warn that the topic is complex and is only available from a more complex level of information.

More generally, the space in the database for a given topic (keyword) and level will be kept whether the content is available or not. This will allow the management of the database to be kept simple, appropriate messages (informing customers that content is missing) in place of the content to be stored and updates to the database to be facilitated if the content happens to be available at a later stage.

Whilst the invention has been described with respect to the Internet, it is equally application to CD-ROM, WAP phone, any other electronic publishing technology.

1. A system for storage and retrieval of data including data relating to a plurality of levels of information comprising a store and a retrieval engine: the store comprising:
a plurality of storage areas each being divided into a plurality of segments and being configured such that data relating to a given level of information for a topic is stored in a segment of one of the storage areas and data relating to at least one other level of information on the topic is stored in a corresponding segment of at least one other one of the storage areas;
the retrieval engine comprising:
means for determining a selected level of information on a topic to be retrieved in response to a user request;
means for retrieving data from a segment of the one of the plurality of storage areas comprising the selected level of information on a topic for display to a user; and
means for retrieving data relating to the at least one other level of information on the same topic from corresponding segment of the at least one other storage area in response to a request to change information level.

2. A system according to claim 1, wherein the segments each have an address such that segments in different storage areas relating to the same topic have a corresponding address within their respective storage areas.

3. A system according to claim 1 or 2, wherein the segments each have an address such that segments in different storage areas relating to the same topic have a corresponding address within their respective storage areas.

4. A system according to claim 1, 2 or 3, wherein each storage area comprises a uniquely identifiable database.

5. A system according to any of claims 1 to 4, wherein the storage areas each comprise a numbered database and segments within each database have an address, wherein any given segment is uniquely identifiable by an address and database number.

6. A system according to claim 5, wherein each segment of a numbered database has a corresponding segment in each of the other numbered databases with a corresponding address, each segment being uniquely identifiable by the address and database number.

7. A system according to any preceding claim, wherein each segment is referenced by one or more keywords.

8. A system according to claim 7, wherein the keywords for a segment of one storage area are the same as keywords for a segment relating to the same topic of another storage area.

9. A method of retrieving data in a data structure in which data relating to a plurality of levels of information are stored in a plurality of storage areas, each storage area being divided into a plurality of segments, the plurality of storage areas being configured to store data relating to a level of information on a given topic, and data relating to other levels of the information on the topic in corresponding segments of other storage areas, comprising:
determining a selected level of information on a topic to be retrieve in response of a user request;
retrieving data from a segment of one of the plurality of storage areas comprising the selected level of information on the topic for display to the user; and
retrieving data relating to another level of information on the same topic from a corresponding segment of another storage area in response to a request to change information level.

10. A method according to claim 9, further comprising storing a default level of information to be retrieved for a given user, and changing the default level in response to a user request.

11. A method according to claim 9 or 10, wherein information stored in corresponding segments relate to identical keywords.

12. A method according to claim 9, 10 or 11, wherein information stored in any given level can be searched and retrieved independently from the other levels, and without retrieving any of the information stored in any of the other levels.

13. A method according to any of claims 9 to 12, further comprising:
analysing a request for information to determine whether information exists at an appropriate level within the data structure; and
in the event that information is not available, providing a response to a user that information is available at other levels or not available at all.

14. A method according to claim 13, further comprising:
identifying a segment or a group of segments in a storage area relating to the requested level of information;
identifying that the information is not available at the requested level;
analysing corresponding segments in other storage areas to determine whether information is available at other levels; and
providing a response to a user indicating levels at which information is available if available and that the information is not available if not available.

15. A computer program including computer program code which, when executed on a computer, executes the method steps of any of claims 9 to 14.

16. A computer readable storage medium having stored thereon a computer program according to claim 15.

17. A method of delivering data comprising the method of retrieving data according to any of claims 9 to 14 and delivering the data so retrieved over a computer network.

18. A system according to any of claims 1 to 8, wherein the means for determining is a determiner and the means for retrieving comprises a retriever.

19. A system for storage and retrieval of data including data relating to a plurality of levels of information comprising a store and a retrieval engine:
the store comprising:
a plurality of storage areas each being divided into a plurality of segments and being configured such that data relating to a given level of information for a topic is stored in a segment of one of the storage areas and data relating to at least one other level of information on the topic is stored in a corresponding segment of at least one other one of the storage areas;
the retrieval engine comprising:
a determiner for determining a selected level of information on a topic to be retrieved in response to a user request;
a first retriever for retrieving data from a segment of the one of the plurality of storage areas comprising the selected level of information on a topic for display to a user; and
a second retriever for retrieving data relating to the at least one other level of information on the same topic from corresponding segment of the at least one other storage area in response to a request to change information level.
